(19) United States
(12) Patent Application Publication
(10) Pub. No.: US 2012/0014118 A1
(43) Pub. Date: Jan. 19, 2012

(54) Method and System for Replacing a Plasma Lamp Using a Removable Base Member from a Resonator Assembly

(75) Inventors: Frederick M. Espiau, Topanga, CA (US); Timothy J. Brockett, Canoga Park, CA (US); Mehran Matloubian, Encino, CA (US)

(73) Assignee: Topanga Technologies, Inc., Canoga Park, CA (US)

(21) Appl. No.: 12/794,295

(22) Filed: Jun. 4, 2010

Related U.S. Application Data
(60) Provisional application No. 61/185,992, filed on Jun. 10, 2009.

(51) Int. Cl. F21V 21/00; B23P 19/04

(52) U.S. Cl. 362/382; 29/428

(57) ABSTRACT

A method and system for replacing an electrodeless plasma lamp from a resonator assembly. The system includes a base support and a post member. The base support is coupled to the resonator assembly. The post member supports the bulb and is coupled to the base support through a mating region.

### CROSS-REFERENCE TO RELATED APPLICATION

This patent application claims priority to U.S. Provisional Application No. 61/185,992 filed Jun. 10, 2009, commonly assigned, and hereby incorporated by reference.

### BACKGROUND OF THE INVENTION

The present invention relates generally to lighting techniques. In particular, the present invention provides a method and device using a plasma lighting device having one of a plurality of base configurations. More particularly, the present invention provides a method and resulting system for removing and preferably replacing a plasma bulb for a lighting device, which can be used for a variety of applications. Merely by way of example, such plasma lamps can be applied to applications such as stadiums, security, parking lots, military and defense, streets, large and small buildings, vehicle headlamps, aircraft landing, bridges, warehouses, uv water treatment, agriculture, architectural lighting, stage lighting, medical illumination, microscopes, projectors and displays, any combination of these, and the like.

From the early days, human beings have used a variety of techniques for lighting. Early humans relied on fire to light caves during hours of darkness. Fire often consumed wood for fuel. Wood fuel was soon replaced by candles, which were derived from oils and fats. Candles were then replaced, at least in part by lamps. Certain lamps were fueled by oil or other sources of energy. Gas lamps were popular and still remain important for outdoor activities such as camping. In the late 1800, Thomas Edison, who is one of the greatest inventors of all time, conceived the incandescent lamp, which uses a tungsten filament within a bulb, coupled to a pair of electrodes. Many conventional buildings and homes still use the incandescent lamp, commonly called the Edison bulb. Although highly successful, the Edison bulb consumed much energy and was generally inefficient.

Fluorescent lighting replaced incandescent lamps for certain applications. Fluorescent lamps generally has a tube containing a gaseous material, which is coupled to a pair of electrodes. The electrodes are coupled to an electronic ballast, which helps ignite the discharge from the fluorescent lighting. Conventional building structures often use fluorescent lighting, rather than the incandescent counterpart. Fluorescent lighting is much more efficient than incandescent lighting, but often has a higher initial cost.

Shuji Nakamura pioneered the efficient blue light emitting diode, which is a solid state lamp. The blue light emitting diode forms a basis for the white solid state light, which is often a blue light emitting diode within a bulb coated with a yellow phosphor material. Blue light excites the phosphor material to emit white lighting. The blue light emitting diode has revolutionized the lighting industry to replace traditional lighting for homes, buildings, and other structures.

Another form of lighting is commonly called the electrodeless lamp, which can be used to discharge light for high intensity applications. Frederick M. Espiau was one of the pioneers that developed an improved electrodeless lamp. Such electrodeless lamp relied upon a solid ceramic resonator structure, which was coupled to a fill enclosed in a bulb. The bulb was coupled to the resonator structure via RF feeds, which transferred power to the fill to cause it to discharge high intensity lighting. Although somewhat successful, the electrodeless lamp still had many limitations. As an example, electrodeless lamps have not been successfully deployed in high volume for general lighting applications. Additionally, electrodeless lamps are generally difficult to disassemble and assemble leading to inefficient use of such lamps and difficulty to manufacture. These and other limitations may be described throughout the present specification and more particularly below.

From the above, it is seen that improved techniques for lighting are highly desired.

### BRIEF SUMMARY OF THE INVENTION

According to the present invention, techniques for lighting are provided. In particular, the present invention provides a method and device using an electrodeless plasma lighting device having one of a plurality of base configurations. Merely by way of example, such plasma lamps can be applied to applications such as stadiums, security, parking lots, military and defense, streets, large and small buildings, vehicle headlamps, aircraft landing, bridges, warehouses, uv water treatment, agriculture, architectural lighting, stage lighting, medical illumination, microscopes, projectors and displays, any combination of these, and the like.

In a preferred embodiment, the present method and apparatus provides a removable support base member, which can be coupled to or decoupled to a post member configured to a bulb. The post member supports the bulb and is coupled to a base support in a removable manner or permanent manner. Such removable manner is created through a mating region in the base support member. The post member is coupled to the base support at the mating region through any suitable means, including but not limited to threaded connection, pressure fitting, or any other suitable locking means. The base support is attached to the housing structure of the lamp in either a permanent or removable manner. In providing a removable post member and base support, an efficient method is created for changing of bulbs upon failure. Such post and bulbs can be manufactured at a standard size in order to create uniformity amongst applications utilizing the plasma lamp.

In a specific embodiment, the present invention provides a method for configuring an electrodeless plasma lamp apparatus. The method includes providing a support base comprising a first surface region and a second surface region. The support base includes a thickness provided between the first surface region and the second surface region according to a specific embodiment. The support base comprises a mating region configured within one or more portions of the first surface region. The method also includes providing a post member having a first end and a second end. In a preferred embodiment, the first end is configured for holding a bulb comprising a fill material. The method also includes receiving the post member by the mating region to support the post member.

Still further, the present invention provides an electrodeless plasma lamp apparatus. The apparatus includes a bulb comprising a fill material and a post member having first end and a second end. The first end is configured for coupling to a bulb. The second end is configured to be received by a mating region to support the post member. Of course, there can be other variations, modifications, and alternatives.

Benefits are achieved over pre-existing techniques using the present invention. In a preferred embodiment, the present apparatus and method includes a replaceable gas filled vessel, including a support body, for easy repair and maintenance. In a specific embodiment, the present invention provides a method and device having configurations of input, output, and feedback coupling elements that provide for electromagnetic coupling to the bulb whose power transfer and frequency resonance characteristics that are largely independent of the conventional dielectric resonator, but can also be dependent upon conventional designs. In a preferred embodiment, the present invention provides a method and configurations with an arrangement that provides for improved manufacturability as well as design flexibility. Other embodiments may include integrated assemblies of the output coupling element and bulb that function in a complementary manner with the present coupling element configurations and related methods for street lighting applications. Still further, the present method and device provide for improved heat transfer characteristics, as well as further simplifying manufacturing and/or retrofitting of existing and new street lighting, such as lamps, and the like. In a specific embodiment, the present method and resulting structure are relatively simple and cost effective to manufacture for commercial applications. Depending upon the embodiment, one or more of these benefits may be achieved. These and other benefits may be described throughout the present specification and more particularly below.

The present invention achieves these benefits and others in the context of known process technology. However, a further understanding of the nature and advantages of the present invention may be realized by reference to the latter portions of the specification and attached drawings.

### BRIEF DESCRIPTION OF THE DRAWINGS

FIG. 1 is a simplified diagram of an electrodeless plasma lamp device according to an embodiment of the present invention;

FIG. 2 is a simplified diagram of a removable post assembly according to an embodiment of the present invention;

FIG. 3 is a simplified diagram of the post assembly removed from the support base according to an embodiment of the present invention;

FIG. 4 is a simplified diagram of a first configuration of the gas-filled vessel for the plasma lamp according to an embodiment of the present invention;

FIG. 5 is a simplified diagram of a second configuration of the gas filled vessel for the plasma lamp according to an alternative embodiment of the present invention;

FIG. 6 is a simplified diagram of a gas filled vessel with a support body according to an embodiment of the present invention;

FIG. 7 is a simplified diagram of a gas filled vessel without a support body according to an embodiment of the present invention;

FIG. 8 is a simplified diagram of a third configuration of the gas filled vessel for the plasma lamp according to an alternative embodiment of the present invention;

FIG. 9 is a simplified diagram of a fourth configuration of the gas filled vessel for the plasma lamp according to an alternative embodiment of the present invention;

FIG. 10 is a simplified diagram of a method of removing a gas filled vessel according to an embodiment of the present invention; and

FIG. 11 is a simplified diagram of a method of replacing a gas filled vessel according to an embodiment of the present invention.

### DETAILED DESCRIPTION OF THE INVENTION

According to the present invention, techniques for lighting are provided. In particular, the present invention provides a method and device using an electrodeless plasma lighting device having one of a plurality of base configurations. Merely by way of example, such plasma lamps can be applied to applications such as stadiums, security, parking lots, military and defense, streets, large and small buildings, vehicle headlamps, aircraft landing, bridges, warehouses, uv water treatment, agriculture, architectural lighting, stage lighting, medical illumination, microscopes, projectors and displays, any combination of these, and the like.

The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.
Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object. Additionally, the terms “first” and “second” or other like descriptors do not necessarily imply an order, but should be interpreted using ordinary meaning.

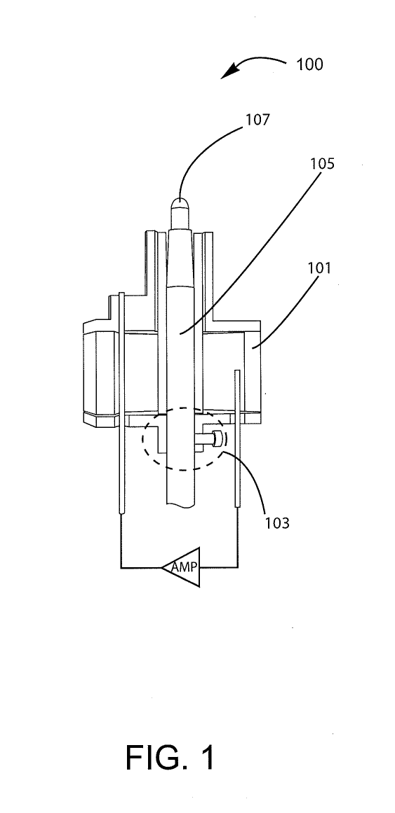

FIG. 1 is a simplified diagram of an electrodeless plasma lamp device 100 according to an embodiment of the present invention. This diagram is merely an example, which should not unduly limit the scope of the claims herein. One of ordinary skill in the art would recognize other variations, modifications, and alternatives. As shown, the plasma lamp device has a housing 101 having a spatial volume defined within the housing. The spatial volume has an inner region and an outer region. In a specific embodiment, the housing can be made of a suitable material, which is electrically conductive. The housing can be made of a metal, a dielectric, or a semiconductor, or any combination of these materials, including molded, welded, stamped, or other configurations as long as the surface of the material is covered/coated with an electrically conductive layer. Alternatively, the housing can be made of other materials. As an example, the housing is made of aluminum, copper, plastic (which can be coated with a conductive metal material or conductive polymer), but can be others. Of course, there can be other variations, modifications, and alternatives.

In a specific embodiment, the device has a support region 103 coupled to the inner region of the spatial volume. In a specific embodiment, the support region extends to an outer region of the lower portion of the housing, as shown. In a specific embodiment, the support region includes one or more attachment devices. In a specific embodiment, the one or more attachment devices include set screws, clamps, support members, any combination of these, and other suitable devices. In a specific embodiment, the support region is a portion of the housing, but can also be a separate member attached to the housing. The support member can be made of metal, such as steel, aluminum, or copper, as well as dielectric materials, such as alumina coated with a conductive material, such as silver or others. Alternatively, a combination of materials and/or layers can be used according to other embodiments. Of course, there can be other variations, modifications and alternatives.

As shown, the device also includes a support body 105 having an outer surface region slidably inserted and disposed within or partially disposed the support region. In a specific embodiment, the support body has a support length, a support first end, and a support second end, among other features. The support body can be made of a suitable material such as a dielectric material or others as long as the surface of the material is coated/covered with an electrically conductive layer such as silver. As an example, the support body can be made of an alumina material covered with silver layer or other suitable dielectric material, but it can be other materials. Alternatively, the support body can be a conductive material, which has an overlying metal layer, according to a specific embodiment. As an example, the support body is integral or configured with the housing and made of a conductive material such as aluminum or the like. Of course, there can be other variations, modifications, and alternatives.

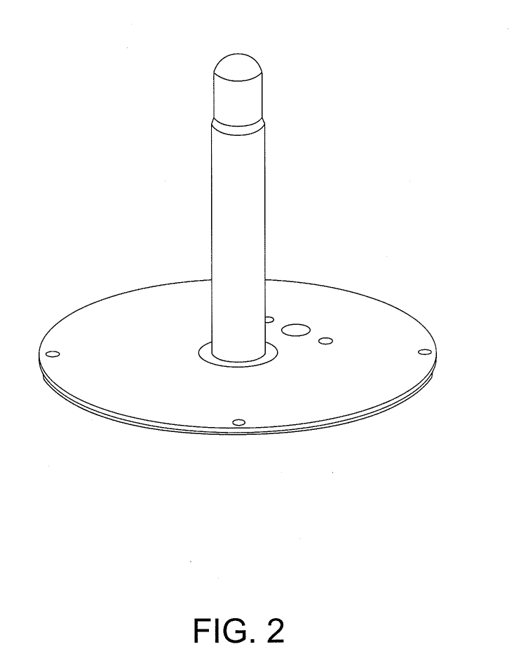

FIG. 2 shows a simplified diagram of a post assembly according to one embodiment of the present invention. This diagram is merely an example, which should not unduly limit the scope of the claims herein. The post assembly includes a base support that is secured to the housing in either a permanent or removable manner. The base support is typically flat and is made from a metal material or composite, including any layered structure, in order to be electrically conductive. The base support has a first and a second surface separated by a thickness. In a specific embodiment, the base support can be attached to the housing through any suitable means including but not limited to screws or welding. The base support can either be electrically or thermally conductive, in order to provide a means through which electrical charge and thermal energy is dissipated into. The base support also includes a mating region which is used to receive and secure the post member during the operation of the lamp.

The post member includes a first end and a second end. The bulb is configured on the first end of the post member. The second end of the post member is coupled to the base support through the mating region. Such coupling can be either permanent or removable. Such method permanently coupling the post member to the base support can be but are not limited to welding, or pressure fitting. In an alternate embodiment of the present invention, a cavity extends throughout the entire thickness of the base support between the first and second surfaces. The post extends through the cavity and is secured to the base support through a rivet on the second surface of the base support. In permanently attaching the post member to the base support, the base support must be removable, to allow for the changing of the post member and the associated bulb.

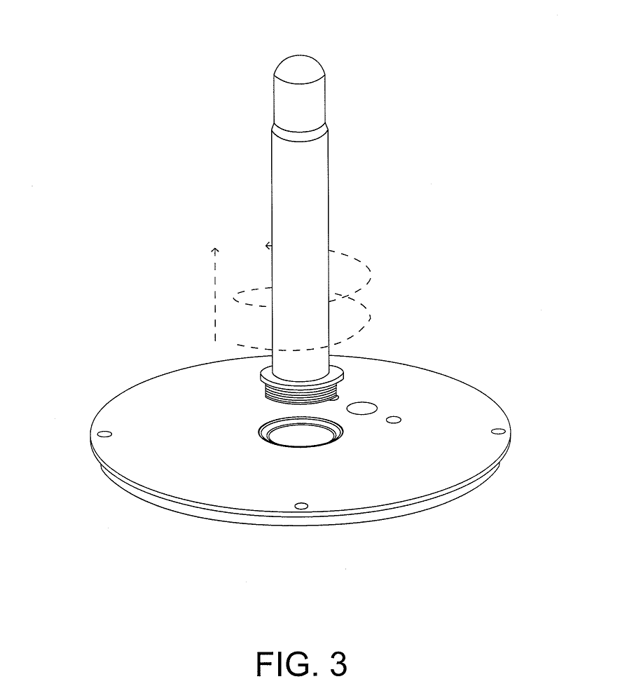

Alternatively the post member can be coupled to the base support, through the mating region, in a removable manner. In coupling the post member to the base support in a removable manner, as shown in FIG. 3, the post member is easily removed from the base support thereby allowing for the quick and easy changing of post members and the attached bulbs. Such methods can be but are not limited to a locking joint, or any other suitable means. In an alternate embodiment, the mating region has a cavity within the first surface of the base support. The cavity is used to receive the second end of the post member. The post member can be secured within the cavity through any suitable means, including but not limited to a locking joint or any other suitable means. Alternatively, the receiving cavity and the second end of the post member are threaded in order to ensure that the post can be coupled and decoupled to the base support.

The post member can be hollow, and contain the RF output coupling-element, that once secured in the base support becomes electrically connected to the base support. Alternatively the post member can be thermally conductive, in order to allow for the dissipation of thermal energy from the bulb. The post member can also be an inductor, thereby increasing the overall inductance of the lamp, and subsequently lowering the resonance frequency of the apparatus.

In a specific embodiment, the support body has a suitable shape and size. The support body can be inserted within the support body according to a specific embodiment. The support body can be annular in shape, and have an outer surface, which is substantially smooth and insertable into the support region. The support body also includes a seat or region for a gas filled vessel according to one or more embodiments. Further details of the gas filled vessel can be found throughout the present specification and more particularly below.

In a specific embodiment, the device also includes a gas-filled vessel 107 coupled to the support first end of the support body. The gas filled vessel has a transparent or translucent body. The body has an inner surface, an outer surface, and a cavity formed within the inner surface. In a preferred embodiment, the cavity is sealed with a fill material. In a specific embodiment, the fill material can be metal halide or other suitable species, or combinations, and the like. In a specific embodiment, the vessel can be made of quartz or other suitable transparent materials capable of enclosing a gas discharge at a high temperature. The temperature of the vessel can be fairly high without damaging the gas filled vessel according to a specific embodiment. In a specific embodiment, the vessel is made of quartz, glass, translucent alumina, or other suitable material. Of course, there can be other variations, modifications, and alternatives.

The device also has an RF source operably coupled to at least the first end of the gas-filled vessel. The RF source is configured to cause a discharge of one or more gases in the gas filled vessel. In a specific embodiment, the RF source is configured at a frequency of 1 GHz and less or 900 MHz and less or preferably 400 MHz and less. Further details of the lamp device, RF source, gas filled vessel, and other elements can be found in co-pending U.S. Provisional Application No. 61/075,735 filed Jun. 25, 2008, which is now U.S. Ser. No. 12/484,933 filed Jun. 15, 2009, commonly assigned, and hereby incorporated by reference for all purposes. Again, there can be other variations, modifications, and alternatives.

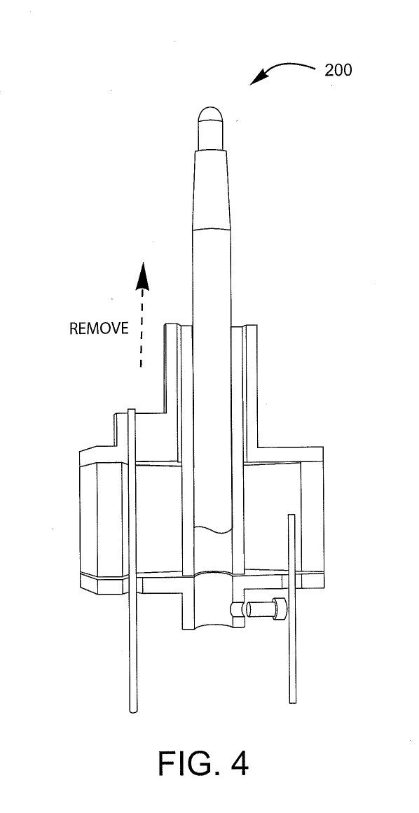

FIG. 4 is a simplified diagram of a first configuration 200 of the gas-filled vessel for the electrodeless plasma lamp according to an embodiment of the present invention. This diagram is merely an example, which should not unduly limit the scope of the claims herein. One of ordinary skill in the art would recognize other variations, modifications, and alternatives. As shown, the support body and gas filled vessel are removed together by sliding the support body from an upper region of the housing. In a specific embodiment, attachment devices engaging the support body to the support region are disengaged. After that, the support body including the vessel slides out (see “Remove”) of the support region according to a specific embodiment. The vessel including the support body is free from the support body and can be replaced with another vessel and/or support body according to a specific embodiment. Of course, there can be other variations, modifications, and alternatives.

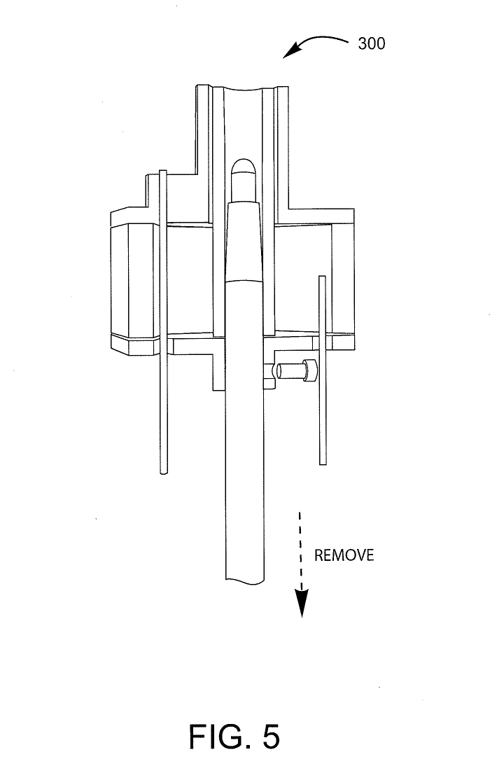

FIG. 5 is a simplified diagram of a second configuration 300 of the gas filled vessel for the electrodeless plasma lamp according to an alternative embodiment of the present invention. This diagram is merely an example, which should not unduly limit the scope of the claims herein. One of ordinary skill in the art would recognize other variations, modifications, and alternatives. As shown, the support body and gas filled vessel are removed together by sliding the support body from a lower region of the housing. In a specific embodiment, attachment devices capable of engaging the support body to the support region have been disengaged. After that, the support body including the vessel slides out of the support region according to a specific embodiment. The vessel including the support body is free from the support region and can be replaced with another vessel and/or support body according to a specific embodiment. Of course, there can be other variations, modifications, and alternatives.

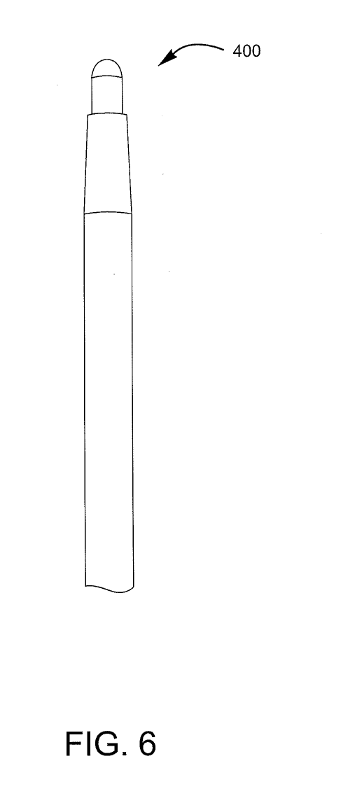

FIG. 6 is a simplified diagram 400 of a gas filled vessel with a support body according to an embodiment of the present invention. This diagram is merely an example, which should not unduly limit the scope of the claims herein. One of ordinary skill in the art would recognize other variations, modifications, and alternatives. As shown, the support body is coupled to gas-filled bulb or bulb without gas if it leaked out according to a specific embodiment. In a specific embodiment, the bulb is a transparent or translucent bulb, which is sealed with a fill material capable of discharge upon application of an RF power source. As shown, the support body can be annular in shape and have a substantially smooth exterior region. The support body also has a substantially constant cross-sectional diameter and length that is suitable for the support body according to a specific embodiment. In other embodiments, the support body can have three or more sides and/or other configurations, including changes in the cross-sectional diameter, that are suitable for supporting the bulb and being slidably insertable into the support region. Of course, there can be other variations, modifications, and alternatives.

In a specific embodiment, the support body having an outer surface region slidably inserted and disposed within or partially disposed within the support region. In a specific embodiment, the support body has a support length, a support first end, and a support second end, among other features. The support body can be made of a suitable material such as a dielectric material or others as long as its surface is coated/covered with an electrically conductive layer. As an example, the support body can be made of any of the materials or combination of materials described herein, but can be others. Further details of the support body and bulb can be found throughout the present specification and more particularly below.

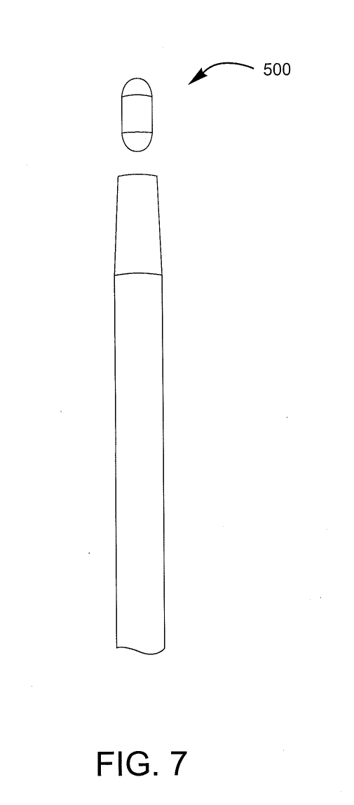

FIG. 7 is a simplified diagram 500 of a gas filled vessel without a support body according to an embodiment of the present invention. This diagram is merely an example, which should not unduly limit the scope of the claims herein. One of ordinary skill in the art would recognize other variations, modifications, and alternatives. As shown, the support body is decoupled from the gas filled vessel or bulb according to a specific embodiment. As shown, the leaky or bad bulb can be replaced with a new or operational bulb according to a specific embodiment. Details of replacing the gas-filled vessel can be found below.

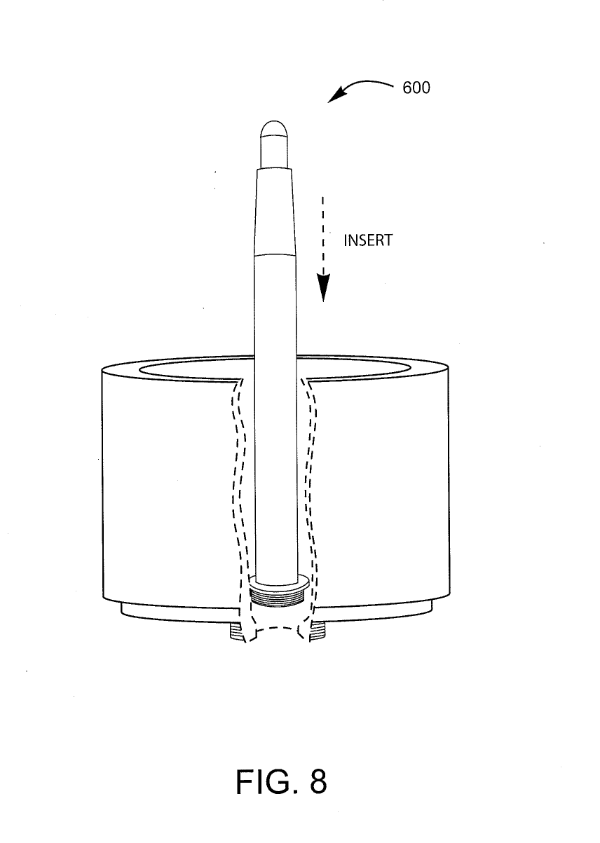

FIG. 8 is a simplified diagram 600 of a third configuration of the gas filled vessel for the electrodeless plasma lamp according to an alternative embodiment of the present invention. This diagram is merely an example, which should not unduly limit the scope of the claims herein. One of ordinary skill in the art would recognize other variations, modifications, and alternatives. As shown, the support body and gas filled vessel are inserted together by sliding the support body through the upper region of the housing. In a specific embodiment, attachment devices that have been disengaged from the support member are engaged. After that, the support member including the vessel is firmly engaged to the support region according to a specific embodiment. In a preferred embodiment, the support body and gas filled vessel are easily inserted and can replace another support body and gas filled vessel. Of course, there can be other variations, modifications, and alternatives.

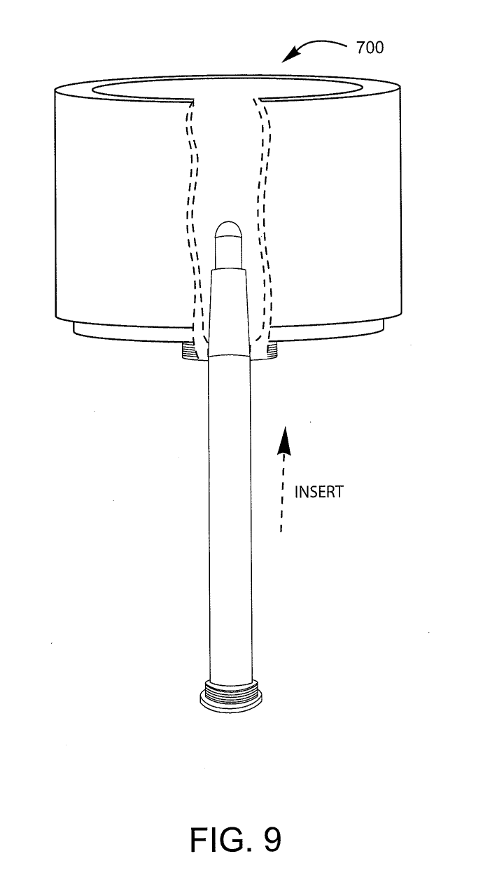

FIG. 9 is a simplified diagram 700 of a fourth configuration of the gas filled vessel for the electrodeless plasma lamp according to an alternative embodiment of the present invention. This diagram is merely an example, which should not unduly limit the scope of the claims herein. One of ordinary skill in the art would recognize other variations, modifications, and alternatives. As shown, the support body and gas filled vessel are inserted together by sliding the support body through the lower region of the housing. In a specific embodiment, attachment devices that have been disengaged from the support body are engaged. After that, the support body including the vessel is firmly engaged to the support region according to a specific embodiment. In a preferred embodiment, the support body and gas filled vessel are easily inserted and can replace another support body and gas filled vessel. Of course, there can be other variations, modifications, and alternatives.

In a specific embodiment, a method for removing a gas filled vessel may be outlined as follows:
1. Start, step 801;
2. Provide an electrodeless plasma lamp apparatus comprising a housing having a spatial volume defined within the housing, step 803;
3. Remove (step 805) a securing device to decouple a first lamp device comprising a first gas filled vessel (which is non-working) coupled to a first support body disposed within or partially disposed from a support region coupled to an inner region of the housing;
4. Remove (step 807) the first lamp device comprising the first gas filled vessel coupled to the first support body disposed within or partially disposed the support region of the housing from the support region, while the support body remains coupled to the first lamp device;
5. Free (step 809) the first lamp device coupled to the support body;
6. Decouple (step 811) the first lamp device from the support body; and
7. Perform other steps as desired.

The above sequence of steps provides a method according to an embodiment of the present invention. In a specific embodiment, the present invention provides a method for removing a non-working or defective bulb and fill from a plasma lamp assembly. Other alternatives can also be provided where steps are added, one or more steps are removed, or one or more steps are provided in a different sequence without departing from the scope of the claims herein. Details of the present method and structure can be found throughout the present specification and more particularly below.

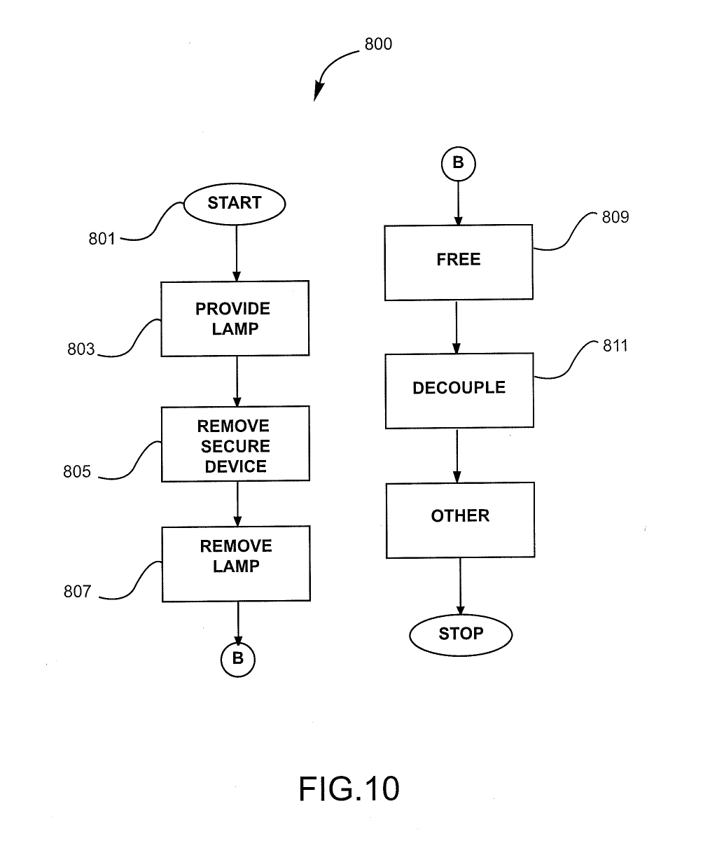

FIG. 10 is a simplified diagram 800 of a method of removing a gas filled vessel according to an embodiment of the present invention. This diagram is merely an example, which should not unduly limit the scope of the claims herein. One of ordinary skill in the art would recognize other variations, modifications, and alternatives. As shown, the method begins with start, step 801. Depending upon the embodiment, start may occur at different stages of removal and/or replacement of the plasma lamp assembly. In a specific embodiment, the present method includes providing a plasma lamp apparatus comprising a housing having a spatial volume defined within the housing, step 803. The plasma lamp apparatus can include those described herein, as well as outside the present specification, and the like.

In a specific embodiment, the present method removes (step 805) a securing device to decouple a first lamp device comprising a first gas filled vessel (which is non-working) coupled to a first support body disposed within or partially disposed from a support region coupled to an inner region of the housing. The securing device can be one or more of suitable devices, such as a screw/thread, locking joint, press fitting, smooth or textured joint, or other devices. In a preferred embodiment, the securing device is a configured male/female threaded locking device, which can be removed by a screw driver or other suitable tool. In addition to the securing device, which may or may not secure, the present method can use an attachment device such as a lock nut, set screw, rivet, or other suitable device. Of course, there can be other variations, modifications, and alternatives.

In a specific embodiment, the method includes removing (step 807) the first lamp device comprising the first gas filled vessel coupled to the first support body disposed within or partially disposed the support region of the housing from the support region of the housing. In a preferred embodiment, the first lamp device remains coupled or preferably attached to the support body. In a preferred embodiment, the first lamp device coupled to the support body is free from the housing. In a specific embodiment, the lamp device with body is removed from an upper region of the housing or top region of the housing. In alternative embodiments, the lamp device with body is removed from a lower region of the housing or bottom region of the housing. Of course, there can be other variations, modifications, and alternatives.

In a preferred embodiment, the method removes and/or frees (step 809) the first lamp device coupled to the support body. In a specific embodiment, the coupled first lamp device is decoupled from the support body, (step 811) the first lamp device from the support body. In a specific embodiment, the lamp device is removed using any suitable mechanical techniques, such as force, drilling, or other chemical or electromagnetic techniques. In a specific embodiment, the entire first lamp device and support body may be disposed or disposable. In other embodiments, the method performs other steps as desired. Of course, there can be other variations, modifications, and alternatives.

In a specific embodiment, a method for removing and replacing gas filled vessel may be outlined as follows:
1. Start, step 901;
2. Provide an electrodeless plasma lamp apparatus comprising a housing having a spatial volume defined within the housing, step 903;
3. Remove (step 905) a securing device to decouple a first lamp device comprising a first gas filled vessel (which is non-working) coupled to a first support body disposed within or partially disposed from a support region coupled to an inner region of the housing;
4. Remove (step 907) the first lamp device comprising the first gas filled vessel coupled to the first support body disposed within or partially disposed the support region of the housing from the support region, while the support body remains coupled to the first lamp device;
5. Free (step 909) the first lamp device coupled to the support body;
6. Decouple (step 911) the first lamp device from the support body;
7. Insert (step 913) a second lamp device comprising a second gas filled vessel coupled to a second support body to a region within or partially within the support region of the inner region of the spatial volume of the housing;
8. Engaging (step 915) the securing device to firmly engage the second lamp device to the support region of the plasma lamp assembly; and
9. Perform (step 917) other steps as desired.

The above sequence of steps provides a method according to an embodiment of the present invention. In a specific embodiment, the present invention provides a method for removing and replacing a non-working or defective bulb and fill from a plasma lamp assembly. Other alternatives can also be provided where steps are added, one or more steps are removed, or one or more steps are provided in a different sequence without departing from the scope of the claims herein. Details of the present method and structure can be found throughout the present specification and more particularly below.

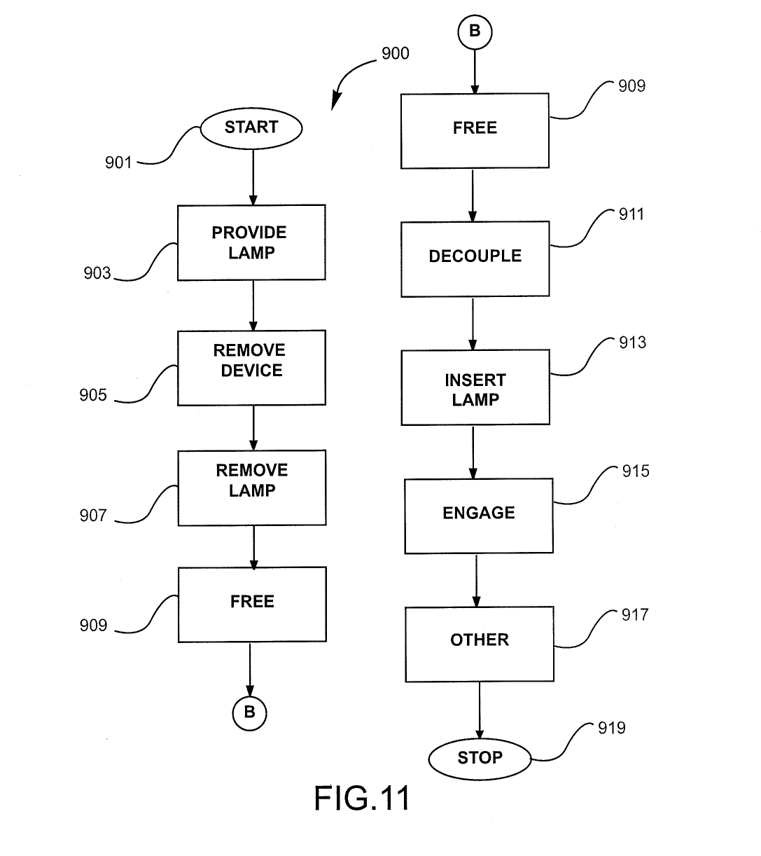

FIG. 11 is a simplified diagram of a method of removing and replacing a gas filled vessel according to an embodiment of the present invention. This diagram is merely an example, which should not unduly limit the scope of the claims herein. One of ordinary skill in the art would recognize other variations, modifications, and alternatives. As shown, the method begins with start, step 901. Depending upon the embodiment, start may occur at different stages of removal and/or replacement of the plasma lamp assembly. In a specific embodiment, the present method includes providing an electrodeless plasma lamp apparatus comprising a housing having a spatial volume defined within the housing, step 903. The plasma lamp apparatus can include those described herein, as well as outside the present specification, and the like.

In a specific embodiment, the present method removes (step 905) a securing device to decouple a first lamp device comprising a first gas filled vessel (which is non-working) coupled to a first support body disposed within or partially disposed from a support region coupled to an inner region of the housing. The securing device can be one or more of suitable devices, such as a screw/thread, locking joint, press fitting, smooth or textured joint, or other devices. In a preferred embodiment, the securing device is a configured male/female threaded locking device, which can be removed by a screw driver or other suitable tool. In addition to the securing device, which may or may not secure, the present method can use an attachment device such as a lock nut, set screw, rivet, or other suitable device. Of course, there can be other variations, modifications, and alternatives.

In a specific embodiment, the method includes removing (step 907) the first lamp device comprising the first gas filled vessel coupled to the first support body disposed within or partially disposed within the support region of the housing, from the support region of the housing. In a preferred embodiment, the first lamp device remains coupled or preferably attached to the support body. In a preferred embodiment, the first lamp device coupled to the support body is free from the housing. In a specific embodiment, the lamp device with body is removed from an upper region of the housing or top region of the housing. In alternative embodiments, the lamp device with body is removed from a lower region of the housing or bottom region of the housing. Of course, there can be other variations, modifications, and alternatives.

In a preferred embodiment, the method removes and/or frees (step 909) the first lamp device coupled to the support body. In a specific embodiment, the coupled first lamp device is decoupled from the support body, (step 911) the first lamp device from the support body. In a specific embodiment, the lamp device is removed using any suitable mechanical techniques, such as force, drilling, or other chemical or electromagnetic techniques. In a specific embodiment, the entire first lamp device and support body may be disposed or disposable. In other embodiments, the method performs other steps as desired. Of course, there can be other variations, modifications, and alternatives. In a specific embodiment, the present method also includes replacing the removed first lamp device, as is further described throughout the present specification and more particularly below.

In a specific embodiment, the present method includes inserting (step 913) a second lamp device comprising a second gas filled vessel coupled to a second support body to a region within or partially within the support region of the inner region of the spatial volume of the housing. In a preferred embodiment, the second lamp device is new or refurbished and is used to replace the first lamp device. In a specific embodiment, the second lamp device can be any suitable device, such as the one described herein. Of course, there can be other variations, modifications, and alternatives.

Next, the method includes a process of engaging (step 915) the securing device to firmly engage the second lamp device to the support region of the plasma lamp assembly according to a specific embodiment. The securing device can be one or more of suitable devices, such as a screw/thread, locking joint, press fitting, smooth or textured joint, or other devices. In a preferred embodiment, the securing device is a configured male/female threaded locking device, which can be attached by a screw driver or other suitable tool. In addition to the securing device, which may or may not secure, the present method can use an attachment device such as a lock nut, set screw, rivet, or other suitable device. In a specific embodiment, the method also includes performing (step 917) other steps as desirable. In a specific embodiment, the method, stops, step 919. Of course, there can be other variations, modifications, and alternatives.

While the above is a full description of the specific embodiments, various modifications, alternative constructions and equivalents may be used. Therefore, the above description and illustrations should not be taken as limiting the scope of the present invention which is defined by the appended claims.

1. An electrodeless plasma lamp apparatus comprising:
a bulb comprising a fill material;
a support base comprising a first surface region and a second surface region, a thickness provided between the first surface region and the second surface region;
a mating region configured within one or more portions of the first surface region; and
a post member having first end and a second end, the first end being configured for holding the bulb, the second end being configured to be received by the mating region to support the post member.

2. The lamp apparatus of claim 1 wherein the mating region comprises a cavity configured for receiving the second end of the post member and coupling the post member to the support base.

3. The lamp apparatus of claim 1 wherein the post member is made from an electrically conductive material.

4. The lamp apparatus of claim 1 wherein the post member is hollow and confines a conductive output element that is in contact with the support base.

5. The lamp apparatus of claim 1 wherein the post member acts as an electrical conductor and wherein the post member acts as a thermal conductor.

6. (canceled)

7. The lamp apparatus of claim 1 wherein the post member is an inductor.

8. The lamp apparatus of claim 1 wherein the support base acts as an electrical conductor.

9. The lamp apparatus of claim 1 wherein the support base acts as a thermal conductor.

10. The lamp apparatus of claim 1 wherein the support base is made of a composite material.

11. The lamp apparatus of claim 1 wherein the support base is comprised of layers of different materials.

12. The lamp apparatus of claim 1 wherein the mating region is threaded.

13. The lamp apparatus of claim 1 wherein the mating region is a locking joint.

14. The lamp apparatus of claim 1 wherein the mating region comprises a twisting lock joint configured for receiving the second end of the post member and coupling the post member to the support base.

15. The lamp apparatus of claim 1 wherein the second end of the post member has a larger volume than the cavity allowing the post member to be coupled to the support base through pressure fitting.

16. The lamp apparatus of claim 1 wherein the mating region comprises a cavity that extends through the entire thickness of the support base, such that the post member extends through the entire support base, and is coupled to the support base through a rivet on the second surface region of the support base.

17. The lamp apparatus of claim 1 wherein the support base is permanently attached to the lamp apparatus.

18. The lamp apparatus of claim 1 wherein the support base is removably attached to the lamp apparatus.

19.-36. (canceled)

37. An electrodeless plasma lamp apparatus comprising:
a bulb comprising a fill material; and
a post member having first end and a second end, the first end being configured for coupling to a bulb, the second end being configured to couple to a mating region to support the post member.
